(19) United States
(12) Patent Application Publication
(10) Pub. No.: US 2016/0070759 A1
(43) Pub. Date: Mar. 10, 2016

(54) System And Method For Integrating Real-Time Query Engine And Database Platform

(71) Applicant: Palo Alto Research Center Incorporated, Palo Alto, CA (US)

(72) Inventor: Eric Huang, San Francisco, CA (US)

(21) Appl. No.: 14/477,777

(22) Filed: Sep. 4, 2014

(51) Int. Cl. G06F 17/30

(52) U.S. Cl. CPC G06F 17/30516; G06F 17/30324

(57) ABSTRACT

Real-time responsiveness to queries regarding data in a relational database can be improved by performing in parallel continuous construction of a graph model of the data and answering the queries based on the graph model. Two processing threads are ran in parallel. The main thread receives user queries regarding data in a database and answers the queries based on a graph data structure stored as a graph model of the data. The main thread also starts a graph update thread, which continuously updates the graph model by requesting a server managing the database to build a description of a graph representative of the data, receiving the description, and storing the description in an initialized graph data structure. The graph data structure previously stored as the graph model is swapped for a more recently completed data structure that represents the data at a later point of time.

### FIELD

This application relates in general to answering queries regarding data in a database, and in particular, to a system and method for integrating real-time query engine and database platform.

### BACKGROUND

A relational database is a database that stores data in a way that allows to recognize relationships between stored data items. For example, a relational database storing data about retail transactions can include several tables, such as a table storing information about customers, a table storing information about products that were purchased by the customers, and a table storing information about products that the customers might want to purchase. The tables are related because they include common entities: the customers. One way to represent these relationships is using a graph model. Thus, customers and products purchased by the customers can be represented as vertices of the graph, while transactions, such as buying the products, can be represented as edges of the graph between the vertices. The products that a customer might purchase can be identified on the graph by finding another customer that has purchased the same product; additional products purchased by the other customer can be identified as the products that the first customer might purchase and that can be recommended to the first customer. Analyzing such a graph, such as by traversing the edges of the graph as described above, allows to identify the relationships between the data items stored in the database.

While tasks related to managing a relational database, such as updating data in the database and building a graph representing the database are commonly performed by a single system called a relational database management system (RDBMS), analyzing the graph to identify relationships between the data items in the database is conventionally done by a different application. For example, such an application may receive a user query for the information in the database and traverse the edges of the graph to generate an answer to such query. One challenge that stands in the way of the usability of such an analytics application is the low speed with which such applications handle user queries.

Conventionally, the speed with which a query can be answered depends not only on the ability of the analytics application to traverse the graph, but also on the speed with which the RDBMS can provide a graph to the application. While the application could theoretically use the same graph to answer all incoming queries, as data in the database can often be updated and a graph built at one point of time can no longer be representative of data in the database at a later point of time, the application risks providing an incorrect answer to the query. Therefore, the application must request from the RDBMS a newly built graph model for each of the queries, wait for the RDBMS to build the graph model and transfer the graph model to the application, and only then analyzes the graph model. Considering that building and providing the graph model takes considerably longer than analyzing the provided graph model, with construction and transferring happening on a minute time scale while responding to the queries happens on a millisecond timescale, answering the queries is unnecessarily delayed, no longer being provided in real time.

As an example of the latency of a conventional system, for the typical conventional system that includes an analytics application and an RDBMS, the time from a moment when the query is posed to a moment when an answer to the query is provided, is 70 seconds. Of those 70 seconds, two seconds are spent by the analytics engine on analyzing the graph and generating the answer to the query, and the rest of the time is spent on building the graph model and providing the graph model to the analytics application. As a result of the mismatch between the speed at which the graph is built and provided and the speed at which the analytics application analyses the graph, the rate at which the application can correctly answer queries is unsatisfactorily low.

Accordingly, there is a need for a way to synchronize building graph models representing data in relational databases and analyzing such models and increase the rate at which data queries are answered based on these graph models.

### SUMMARY

Real-time responsiveness to queries regarding data in a relational database can be improved by performing in parallel continuous construction of a graph model of the data and answering the queries based on the graph model. Two processing threads are initiated and are ran in parallel. The main thread receives user queries regarding data in a database and answers the queries based on a graph data structure stored as a graph model of the data. The main thread also starts a graph update thread, which continuously updates the graph model by requesting a server managing the database to build and stream over a network a description of a graph representative of the data, receiving the description, and storing the description in an initialized graph data structure. After the description is stored, the graph data structure previously stored as the graph model is swapped for a more recently completed data structure that represents the data at a later point of time. As a result, answering the queries accurately does not require waiting for a new graph model to be built, thus reducing the latency of answering the queries.

In one embodiment, a system and method for integrating real-time query engine and database platform are provided. A graph data structure and a graph model including another graph data structure are maintained in a memory. Queries are processed regarding data in a database by a query engine included in one or more servers connected to the memory, including: receiving an input stream including one or more of the queries; and answering the one or more queries based on the graph model. The graph data structure and the graph model are continually updated while the query stream remains open by a graph update engine included in the one or more servers, including: initializing the graph data structure; requesting a description of a graph representative of the data from at least one server managing the database, receiving the description from the at least one server, and storing the description in the initialized graph data structure; and swapping the data structure with the stored description and the another graph data structure included in the graph model, wherein the graph model comprises the graph data structure with the stored description after the swap.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for integrating a real-time query engine and a database platform, in accordance with one embodiment.

FIG. 2 is a flow diagram showing a method for integrating a real-time query engine and a database platform, in accordance with one embodiment.

FIG. 3 is a flow diagram showing a routine for running a graph update thread for use in the method of FIG. 2, in accordance with one embodiment.

FIG. 4 is a flow diagram showing a routine for checking if the graph model has been preprocessed for use in the method of FIG. 2, in accordance with one embodiment.

### DETAILED DESCRIPTION

Latency of processing queries can be reduced by allowing graph building and graph reasoning processes to occur in parallel, not sequentially. Having an in-memory graph model reflecting changes to the data continually available for analysis minimizes the latency of answering queries regarding the data and maximizes real-time responsiveness to the queries.

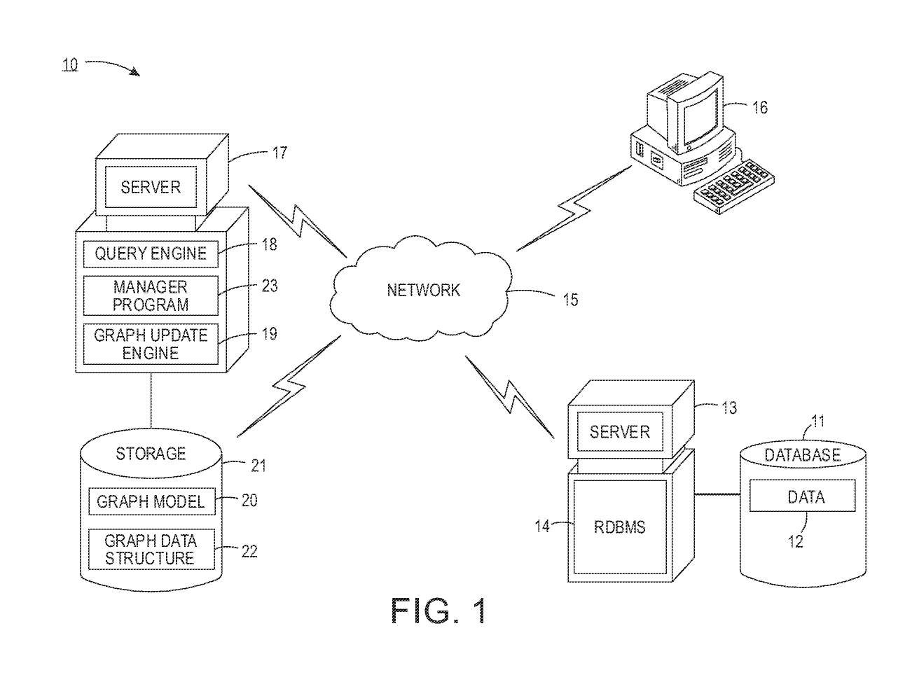

FIG. 1 is a block diagram showing a system 10 for integrating a real-time query engine and a database platform, in accordance with one embodiment. The system 10 includes a relational database 11 of stored data 12. The database 11 can be any structured query language (“SQL”) database, though other kinds of relational databases are also possible. In the description below, the examples of the data 12 are related to retail, such as customers, products, and purchases. However, the data 12 can be any kind of data. For example, if the data relates to medicine, the data items in the database can be doctors, patients, and medical claims. Still other kinds of data 12 are possible.

The database is connected to one or more servers 13 (“graph servers”) that execute an RDBMS 14. In one embodiment, the RDBMS 14 can include SAP HANA, developed by SAP AG of Walldorf, Baden-Württemberg, Germany. In a further embodiment, other kinds of the RDBMS 14 can be used. The RDBMS 14 updates the data 12 in the database 11, such as by adding data 12, deleting data 12, deleting or adding rows in the database 11, and editing existing data 12. Other updating operations can be performed by the RDBMS 14.

The one or more servers 13 are connected to a network 15, which can be a local network or an Internetwork such as the Internet or a cellular network, and through the network 15 can communicate with at least one user device 16. While the user device 16 is shown as desktop computer, the user device 16 can also include laptop computers, smartphones, media players, and tablets. Still other kinds of user devices 16 are possible. The user device 16 can communicate with the RDBMS 14 through the network 15, and the RDBMS 14 can change the data 12 and add new data items upon receiving user commands from the user device 16. Via the network 15, a command-line client of the user devices 16 can interact with a command-line interface of the RDBMS 14. The RDBMS 14 can also update the data 12 based on other factors.

In a further embodiment, the servers 13 can be directly connected to the user device 16, without involvement of the network 15, such as via a wired connection.

Through the network 15, the RDBMS 14 is also connected to one or more servers 17 that implement a query engine 18 and a graph update engine 19. Together, the query engine 18 and the graph update engine 19 run two processing threads that reduce the latency of processing of user queries. The query engine 18 executes a main processing thread as part of which the query engine 18 receives user queries regarding the data 12 and answers these user queries based on a graph model of the data 20, which includes a graph data structure storing a description of a graph representative of the data 12. In one embodiment, the query engine 18 can be the HiperGraph engine described in the commonly-owned U.S. patent application Ser. No. 14/039,941, entitled “System and Method for A High-performance Graph Analytics Engine,” filed on Sep. 27, 2013, pending, the disclosure of which is incorporated by reference. Other kinds of query engines 18 can be used.

The query engine 18 can communicate with one or more user devices 16 over the network 15, receiving queries and sending answers to the queries back to the user devices 16 in real time. For example, through the network 15, the query engine 18 can receive an input stream that includes multiple queries, with opening and closing of the stream being controlled by the user from the user device 16. The query engine 18 can buffer the queries as they are received in a memory, such as the storage 21 connected to the servers 17, periodically extract the queries from the buffer, and combine the queries into batches for more efficient processing. Each batch can include a predefined number of queries. In a further embodiment, each query in the stream is extracted from the stream and answered by the query engine 18 upon being extracted, with no batching occurring. The answers to the received queries can be output by the query engine 18 over the network 15 to the user devices 16, though other ways for the query engine to output answers to the queries are possible. For example, answers can be transmitted to a printer (not shown) over the network 16 and printed out. Still other ways to output the answers are possible. In a further embodiment, the servers 17 be connected directly to the user devices 16, without involving the network 15, such as via a wired connection, and the engine 18 can receive an input stream of queries directly from and output results directly to the user devices 16.

To answer the queries, the query engine 18 preprocesses the graph model 20, such as by calculating one or more statistics associated with the graph model 20, such as centrality, degree of separation between two vertices, and page rank, that are used for answering the queries and analyzes the preprocessed graph model 20 to answer the received queries. The graph model 20 is initialized by the query engine 18 and stored in the storage 21 connected to the servers 17. For example, if the database 11 includes data 12 about retail, the user query can include a customer name or another customer identifier, such as a number, and request a recommendation of a product for the identified customer. In that case, the query engine 18 traverses the edges of the graph described by the graph model 20 and identifies other customers with a purchasing history in common with the customer identified in the query. Customers with a common purchasing history have purchased at least one of the same products in the past; these customers can be represented as vertices in the graph that are connected by edges to one or more of the same vertices representing products. The products purchased by the customers with the common purchasing history and that have not been previously purchased by the customer identified in the query can be presented by the query engine 18 as the products recommended to the customer identified in the query. In one embodiment, analyzing the graph model 20 and answering the queries can be performed as described in the “System and Method for a High-Performance Graph Analytics Engine” application cited supra. Other kinds of analysis can also be performed by the query engine 18.

Also, as part of the execution of the main processing thread, the query engine 18 starts a graph update thread implemented by the graph update engine. 19, which updates the content of the graph model 20, allowing the graph model 20 to remain a representative of the data 12 as the data 12 changes. The graph update engine 19 requests a description of a graph representative of the data 12 by sending executable queries with the request, such as SQL queries, to the RDBMS 14 over the network 15. In particular the graph update engine 19 can include a command-line to communicate with the RDBMS 14 the RDBMS 14 can include au Open Database Connectivity (ODBC) middleware API (not shown) that communicates with the command-client. The communication can be conducted using SQL or a related programming language; other kinds of languages can also be used.

Upon receiving a query requesting the description, the RDBMS 14 executes the received query, building the description as described in a commonly-owned U.S. patent application Ser. No. 14/148,435, entitled “Automated Compilation Of Graph Input For The Hipergraph Solver,” flied Jan. 6, 2014, pending, the disclosure of which is incorporated by reference. Briefly, the RDBMS 14 extracts data 12 from the database 11, processes the extracted data, projects the processed data into intermediate tables, and generates headers for the tables. The RDMBS 14 then writes the tables, headers, and additional tables with data describing graph topology into a suitably formatted text file; the text file is the description of the graph representing the data in the database 12. In one embodiment, the set of results can be buffered in the memory of the database 11 as the result is being prepared. In a further embodiment, the result can be buffered in an external medium (not shown), such as a disk storage. Also, as part of the query execution, the result of the execution, the text file, is streamed over the network 15 to the query engine 18.

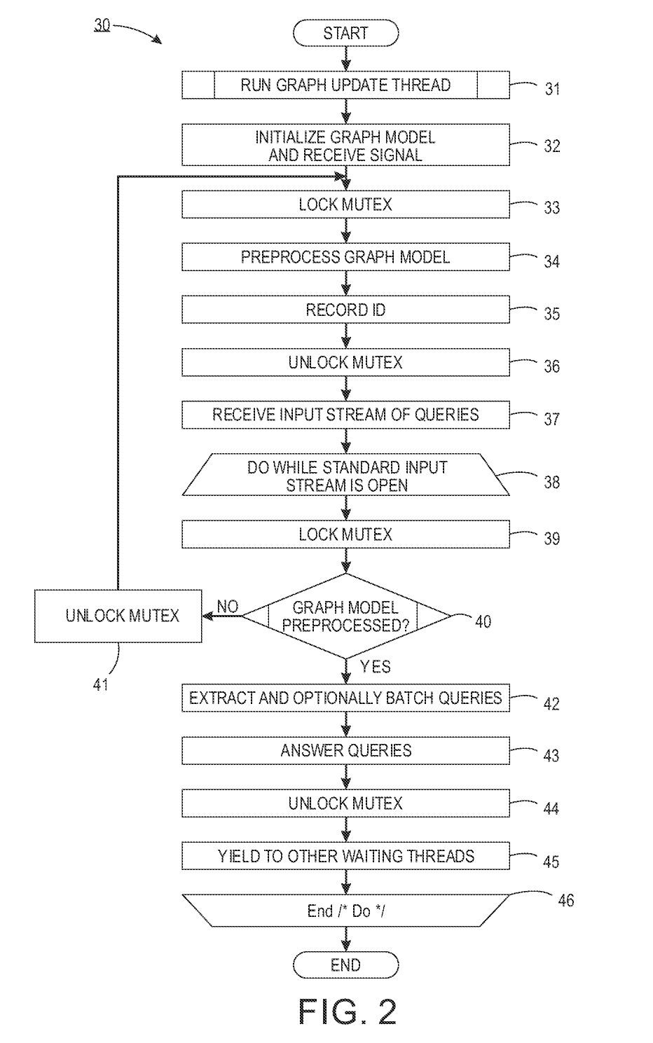

Once the result is transmitted by the RDBMS 14, the graph update engine 19 stores the received result in a graph data structure 22 initialized in a storage 21, such as by allocating memory to in the storage 21 for the data structure 22, and the data structure 22 with the stored results is given an identifier, as further described below beginning with reference to FIG. 2. The assignment of the identifier can happen concurrently with the initialization.

As described further below beginning with reference to FIG. 2 after the results are stored in the graph data structure 22, the engine 19 swaps the contents of the graph data structure 22 and contents of the graph model 20, thus updating the graph model with the more recent results of execution of the query by the RDBMS 14. In one embodiment, the swap can be a pointer-based swap, allowing a nearly instantaneous swap of the contents of the graph data structure 22 and the graph model 20. Manipulating only the pointers of the graph data structure 22 and the graph data structure included as part of the graph model 20, and avoiding creating deep copies of the data structures allows the pointer-based swap to occur nearly instantaneously. In a further embodiment, other ways to perform the swap are possible.

The time necessary to update the graph model 20 depends on the amount of data 12 stored in the database 11. For example, for a graph data structure 22 that describes a graph with seven million vertices, the time to update the graph model may be around one minute, though other speeds of construction are also possible.

As both of the query engine 18 and the graph update engine 19 access the same resource, the graph model 20, the query engine 18 and the graph-building engine 18 must be synchronized to avoid conflicts in accessing the graph model 20. The synchronization is accomplished through a use of mutual exclusion object (mutex) (not shown), a program object that, when locked either by the engine 18 or the engine 19, provides exclusive access to the graph model 20 to either the engine 18 or the engine 19 respectively; any other computing processes that need to use the graph model 20 are paused until the model 21 is unlocked. The engine 18 and the engine 19 can request a manager program 23 to lock the mutex, which will grant the lock request if the mutex is not locked by another entity, such as the engine 18 or the engine 19. If the mutex is already locked, the requesting entity can be queued by the manager program 23, and can be granted the lock on the mutex upon the mutex being unlocked by the entity that was previously using the mutex. The unlocking of the mutex can be automatic upon a completion of particular steps executed by the engine 18 or the engine 19. Other ways to accomplish locking and unlocking of the mutex are possible. In one embodiment, the mutex can be given the identifier m, though other identifiers, such as different numbers or letters, are possible.

By using the mutex, the engine 18 and the engine 19 can gain exclusive access to the graph model 20 when necessary, as further described below beginning with reference to FIG. 2. For example, the engine 18 can use the mutex when performing the swap of the contents of the graph data structure 22 and the graph model 20; as the swap makes the graph model 20 unavailable for processing by the engine 18 for a short amount of time, locking the mutex by the engine 19 prevents the engine 18 from attempting to use the graph model 20 to answer user queries. Similarly, by locking the mutex, the engine 18 can have uninterrupted access to the graph model 20 while answering user queries.

The one or more servers 13 and the one or more servers 17 can include components conventionally found in programmable computing devices, such as a central processing unit, memory, input/output ports, network interfaces, and non-volatile storage, although other components are possible. The servers 13 and 17 can each include one or more modules for carrying out the embodiments disclosed herein. The modules can be implemented as a computer program or procedure written as source code in a conventional programming language and that is presented for execution by the central processing unit as object or byte code. Alternatively, the modules could also be implemented in hardware, either as integrated circuitry or burned into read-only memory components, and each of the servers 13 and servers 17 can act as a specialized computer. For instance, when the modules are implemented as hardware, that particular hardware is specialized to perform the updating of the graph model 20 and the graph data structure 22 and other computers without the hardware cannot be used for that purpose. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

The one or more servers 13 and the one or more servers 17 can be in a cloud-computing environment or be dedicated servers. In one embodiment, the one or more servers 17 can be 24-core Intel Xeon 3.33 GHz servers with 96 GB of RAM, though other kinds of servers can also be used as the servers 17.

While the graph update thread is described above as being executed by the graph update engine 19 on the servers 17, in a further embodiment, the graph update thread may be implemented via a bash script executed outside of the servers 17. In such a case, synchronization may occur by using files to buffer the graph model 20, with the bash script and the query engine gaining exclusive access to the graph model via one or more file-locking mechanisms provided by the system 10.

As a result of the interaction between the manager program 23, the query engine 18, and the graph-building engine 19, the system 10 can run multiple processing threads at the same time. The main thread, controlled by the query engine 18, initiates the execution of the graph update thread by the graph update engine 19 and answers received user queries based on the graph model 20 updated by the graph update thread. The graph update thread runs concurrently with the main thread, reflecting any changes made to the data 12 in the graph model 20. As a result of this arrangement, in one embodiment, the speed with which a user queries are answered can increase from 17 queries per second for a conventional system, to 70 queries per second achievable by the system 10, though other speeds are possible.

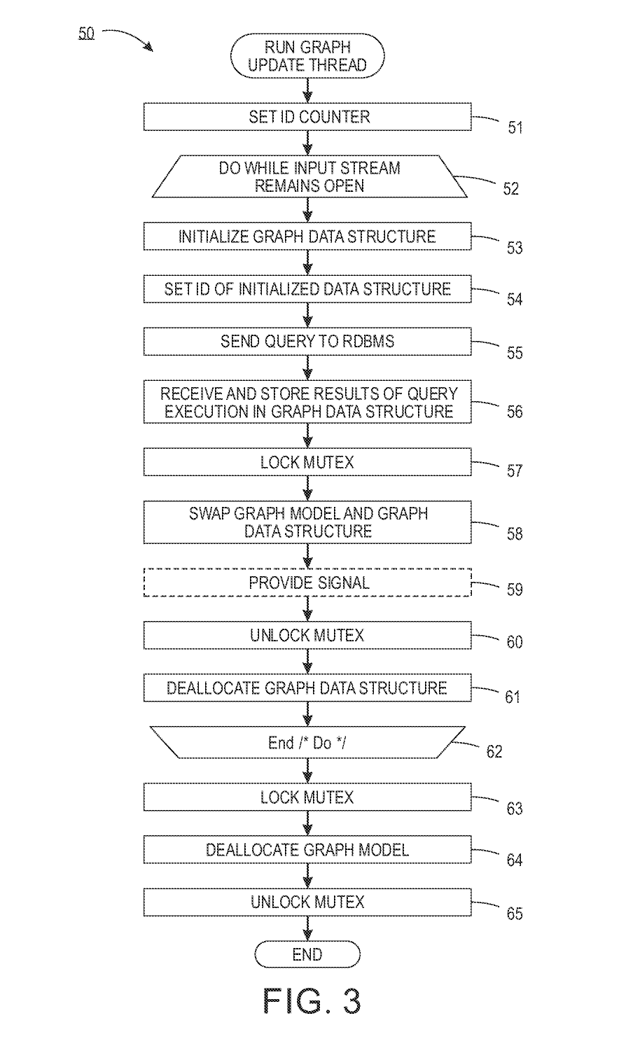

FIG. 2 is a flow diagram showing a method 30 for integrating real-time query engine and database platform, in accordance with one embodiment. The method 30 can be executed on the system of FIG. 1. A graph update thread is initiated and ran simultaneously with steps 32-46 described below (step 31), as further described with reference to FIG. 3. As described below with reference to FIG. 3, the graph update thread requests from the RBDMS 14 a description of a graph representative of the data 12, and after receiving the description, stores the description in the graph data structure. Also as part of the thread, the graph data structure 22 and the graph data structure stored as the graph model 20 are swapped, resulting in the description of the graph being stored as part of the graph model 20.

Before at least one swap is performed by the graph update thread, the graph model 20 does not include a description of the graph representative of the data 12 in the database and cannot be used to answer queries. The graph model 20 is initialized by the query engine 18, such as in the storage 21, and once the swap has been performed once by the graph update thread and the graph model 20 includes the description that can be used to answer queries, a signal is received by the query engine 18 (step 32). The signal can be a condition of variable with an identifier, such as q or another letter or number, though other kinds of signals are possible. In a further embodiment, the initialization can also begin at a different point of the method 30, such as prior to the start of the execution of the graph update thread in step 31.

After the signal is received (step 32), the mutex is locked by the query engine 18 (step 33) and the graph model 20 is preprocessed (step 34). The preprocessing can include determining one or more statistics associated with the graph model 20, such as centrality, degree of separation between two vertices, and page rank, though other kinds of preprocessing is possible. An identifier of the preprocessed graph is a recorded (step 35), and the mutex is unlocked by the query engine 18 (step 36).

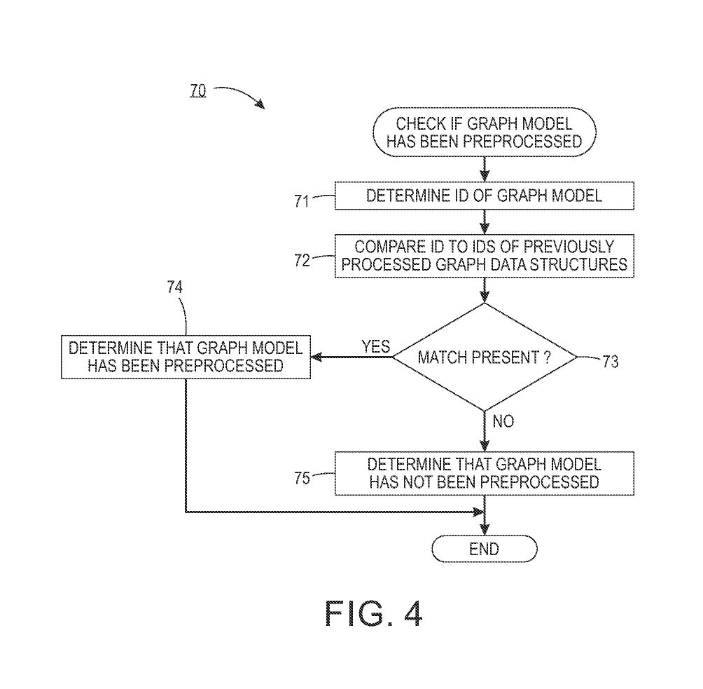

The user opens an input stream of queries on the user device 16 and the query engine 18 receives the input stream of one or more queries, which are buffered in the storage 20 as they are received (step 37). Following the opening of the stream and as long as the stream remains open, an iterative processing loop is continually executed by the query engine 18 (step 38). The mutex is locked by the query engine 18 (step 39) and whether the graph model 20 has been preprocessed is checked (step 40), as further described with reference to FIG. 4. If the graph model 20 has not been preprocessed (step 40), the mutex is unlocked (step 41), and the method 30 returns to step 33 described above. If the graph model 20 has been preprocessed (step 40), the queries are extracted from the buffer and are optionally combined together into one or more batches of a predefined number of queries (step 42).

The query engine 18 answers the queries based on the graph model 20 (step 43). For example, if each of the queries includes a customer identification, the query engine 18 identifies one or more products to be recommended to the customers based on products bought by customers with a common purchasing history, and outputs the recommendations as answers to the queries. In one embodiment, the analysis of the graph model 20 and answering the queries can be performed as described in the commonly-owned U.S. patent application Ser. No. 14/039,941, entitled “System and Method for A High-performance Graph Analytics Engine,” filed on Sep. 27, 2013, pending, the disclosure of which is incorporated by reference, though other ways to answer the queries are possible. Further, in one embodiment, the query engine 22 answers all queries in a single batch before the method 30 moves to the next step described below. In a further embodiment, the method 30 moves to the next step after answering each of the queries.

After answering the queries (step 43), the query engine 18 unlocks the mutex (step 44), and yields the mutex to the graph update thread (step 45), allowing, the graph update thread to again swap the graph data structure 22 and the graph model 20. In a further embodiment, the query engine 18 can also yield the mutex to other processing threads. Processing continues (step 46) as long as the query stream remains open, after which the processing loop is exited, the processing threads are joined, and the method 30 ends.

Continually updating the graphs data structure 22 and the graph model 20 concurrently with the execution of the method 30 allows the query engine 18 to have up-to-date graph model 20 for answering user queries. FIG. 3 is a flow diagram showing a routine 50 for running a graph update thread for use in the method 30 of FIG. 2, in accordance with one embodiment. Initially, an identifier counter is set to a particular starting identifier, such as the number zero, though other starting identifiers are possible (step 51). After the counter is set (step 51), the routine 50 goes through an interactive processing loop as long as the input stream remains open (step 52). The graph update engine initializes the graph data structure. 22, such as in the storage 19 connected to the query servers 17 (step 53), and gives the data structure 22 an identifier based on the set identifier counter (step 54); for example, if the counter was set to zero, the graph data structure initialized at the first iteration of the loop can be given the identifier 1, during the second iteration can be given the identifier 2, and so forth. Other ways to set the graph data structure 22 identifier are possible. The assignment of the identifier (step 54) can happen concurrently with the initialization (step 53).

The graph update engine 19 sends over the network 15 a query, such as an SQL query, to the RDBMS 14, requesting the RDBMS 14 to provide a description of a graph representing the data 12 in the database (step 55). The description is streamed by the RDBMS 14, described above with reference to FIG. 1, received by the graph update engine 19, which stores the results in the initialized graph data structure 22 (step 56). The mutex is locked by the graph update engine 19 (step 57), and the graph model 20 is swapped with the graph data structure 22 by the graph update engine 19, with the description received in step 56 now being stored in the graph model 20 (step 58). In one embodiment, the swap can be a pointer-based swap, which avoids creating a deep copy of the graph data structure 22 and occurs nearly instantaneously. Other ways to perform the swap are possible.

Once the swap is completed, the graph update engine 19 provides a signal, such as a conditional variable, to the query engine. 18 that the graph model 20 can be used to answer user queries (step 59), which the query engine 18 receives in step 32 of the method 30 described above. In one embodiment, the signal is provided only during the first iteration of the processing loop. In a further embodiment, the signal is provided after each swap, even though the query engine 22 does not need to wait for the signal to answer queries.

The graph update engine 19 unlocks the mutex (step 60), and deallocates the graph data structure 22, resulting in the data stored in the graph data structure 22 being discarded (step 61). The deallocation of the graph data structure 19 in step 59 makes sure that no more than two graph data structures exist in the system 10 at any point of time. Processing continues (step 62) as long as the query stream remains open, after which the processing loop is exited, and the mutex is locked (step 63). The graph model 20 is deallocated (step 64), discarding the contents of the model 20, and the mutex is unlocked (step 65), ending the routine 50.

As the graph update engine 18 continuously replaces the graph data structures stored as the graph model 20, checking whether the graph model 20 has been previously preprocessed is necessary to make sure that the graph model 20 is usable by the query engine 18 for answering queries. FIG. 4 is a flow diagram showing a routine 70 for checking if the graph model 20 has been preprocessed for use in the method 30 of FIG. 2. The query engine 18 reads the identifier of the graph data structure stored as the graph model 20 (step 71), and compares the read identifier to identifiers of graph data structures previously processed as graphs models 20 (step 72). If the graph data structure stored as the graph model 20 matches one of the previously preprocessed graphs data structures based on the comparison (step 73), the query engine 18 determines that the graph model 20 has previously been preprocessed (step 74), ending the routine 70. If the graph data structure stored as the graph model 20 does not match one of the previously preprocessed graphs data structures based on the comparison (step 73), the query engine 18 determines that the graph model 20 has not previously been preprocessed (step 75), ending the routine 70.

While the invention has been particularly shown and described as referenced to the embodiments thereof, those skilled in the art will understand that the foregoing and other changes in form and detail may be made therein without departing from the spirit and scope of the invention.

What is claimed is:

1. A system for integrating real-time query engine and database platform, comprising:
a memory configured to store a graph data structure and a graph model comprising another graph data structure;
one or more servers connected to the memory and configured to execute code, comprising:
a query engine configured to process queries regarding data in a database, the query engine comprising:
an input module configured to receive an input stream comprising one or more of the queries; and
an answering module configured to answer the one or more queries based on the graph model; and
a graph update engine configured to continuously update the graph data structure and the graph model while the query stream remains open, comprising:
an initialization module configured to initialize the graph data structure;
a request module configured to request a description of a graph representative of the data from at least one server managing the database, to receive the description from the at least one server, and to store the description in the initialized graph data structure; and
a swap module to swap the data structure with the stored description and the another graph data structure comprised in the graph model, wherein the graph model comprises the graph data structure with the stored description after the swap.

2. A system according to claim 1, further comprising:
a signal module configured to receive a signal that the swap has occurred,
wherein the answering module begins answering the queries upon the signal being received.

3. A system according to claim 2, further comprising:
a preprocessing module configured to preprocess the graph model after each time the swap occurs;
an identifier module configured to associate an identifier with the graph data structure after each time the graph data structure is initialized; and
a recording module configured to record the identifier associated with the graph data structure comprised in the graph model each time the graph model is preprocessed.

4. A system according to claim 3, further comprising:
a checking module configured to check whether the graph data structure comprised in the graph model has been preprocessed, comprising:
a read module configured to read the identifier of the one data structure comprised in the graph model;
a comparison module configured to compare the read identifier to the recorded identifiers; and
a determination module configured to determine whether the graph data structure comprised within the graph model has been preprocessed based on the comparison.

5. A system according to claim 1, further comprising:
a locking module comprised in the graph update engine configured to lock a mutex on the graph model upon storing the description in the graph data structure; and
an unlocking module comprised in the graph update engine configured to unlock the mutex after the swap is performed,
wherein answering the queries by the query engine is paused while the mutex is locked by the locking module.

6. A system according to claim 5, comprising at least one of:
a query locking module comprised in the query engine configured to lock the mutex on the graph model prior to answering the queries; and
a query unlocking module comprised in the graph engine configured to unlock the mutex upon answering a predefined number of the queries,
wherein the swapping by the graph update engine is paused while the mutex is locked by the query engine.

7. A system according to claim 6, further comprising:
an extraction module configured to extract the queries from the input stream; and
a combining module configured to combine the extracted queries into one or more batches,
wherein the predefined number equals the number of the queries in one of the batches.

8. A system according to claim 1, wherein the swap is a pointer-based swap.

9. A system according to claim 1, wherein the description is received from the at least one server over a network.

10. A system according to claim 1, further comprising:
a deallocation module configured to deallocate the graph data structure after the swap and the graph model after the input stream is closed.

11. A method for integrating real-time query engine and database platform, comprising:
maintaining in a memory a graph data structure and a graph model comprising another graph data structure;
processing queries regarding data in a database by a query engine comprised in one or more servers connected to the memory, comprising:
receiving an input stream comprising one or more of the queries; and
answering the one or more queries based on the graph model; and
continuously updating the graph data structure and the graph model while the query stream remains open by a graph update engine comprised in the one or more servers, comprising:
initializing the graph data structure;
requesting a description of a graph representative of the data from at least one server managing the database, receiving the description from the at least one server, and storing the description in the initialized graph data structure; and
swapping the data structure with the stored description and the another graph data structure comprised in the graph model, wherein the graph model comprises the graph data structure with the stored description after the swap.

12. A method according to claim 11, further comprising:
receiving a signal that the swap has occurred,
wherein the queries are answered upon the signal being received.

13. A method according to claim 12, further comprising:
preprocessing the graph model after each time the swap occurs;
associating an identifier with the graph data structure after each time the graph data structure is initialized; and
recording the identifier associated with the graph data structure comprised in the graph model each time the graph model is preprocessed.

14. A method according to claim 13, further comprising:
checking whether the graph data structure comprised in the graph model has been preprocessed, comprising:
reading the identifier of the one data structure comprised in the graph model;
comparing the read identifier to the recorded identifiers; and
determining whether the graph data structure comprised in the graph model has been preprocessed based on the comparison.

15. A method according to claim 11, further comprising:
locking a mutex on the graph model by the graph update engine upon storing the description in the graph data structure; and
unlocking the mutex by the graph update engine after the swap is performed,
wherein answering the queries by the query engine is paused while the mutex is locked by the graph update engine.

16. A method according to claim 15, comprising at least one of:
locking the mutex on the graph model by the query engine prior to answering the queries; and
unlocking the mutex upon answering a predefined number of the queries,
wherein the swapping by the graph update engine is paused while the mutex is locked by the query engine.

17. A method according to claim 16, further comprising:
extracting the queries from the input stream; and
combining the extracted queries into one or more batches,
wherein the predefined number equals the number of the queries in one of the batches.

18. A method according to claim 11, wherein the swap is a pointer-based swap.

19. A method according to claim 11, wherein the description is received from the at least one server over a network.

20. A method according to claim 11, further comprising:
deallocating the graph data structure after the swap; and
deallocating the graph model after the input stream is closed.
